(19) United States
(12) Patent Application Publication
(10) Pub. No.: US 2026/0176122 A1
(43) Pub. Date: Jun. 25, 2026

(54) EMERGENCY SYSTEM FOR AERIAL PLATFORM, AERIAL PLATFORM COMPRISING SAID EMERGENCY SYSTEM AND RELATED EMERGENCY METHOD

(71) Applicant: ISB S.R.L., Gavi (IT)

(72) Inventor: Pierangelo BALLESTRERO, Gavi (IT)

(73) Assignee: ISB S.R.L., Gavi (IT)

(21) Appl. No.: 19/369,813

(22) Filed: Oct. 27, 2025

(30) Foreign Application Priority Data
Dec. 23, 2024 (EP) 24425062.7

(51) Int. Cl. B66F 17/00; B66F 9/12

(52) U.S. Cl. CPC B66F 17/006; B66F 9/127

(57) ABSTRACT

An emergency system for an aerial platform, including a lifting arm associated with a basket and a levelling actuator including a levelling electric motor. The emergency system includes a first automatic control circuit connected to the levelling electric motor, the first automatic control circuit including at least one inclination sensor which can be associated with the basket and a first power driver including a first control logic. The emergency system also includes a second manual control circuit connected to the levelling electric motor, the second manual control circuit including a manual inclination control and a second power driver including a second control logic. The emergency system further includes at least one diverter adapted to alternatively exclude a first functional connection of the levelling electric motor with the first automatic control circuit or a second functional connection with the second manual control circuit.

### FIELD

The present invention relates in its more general aspect to an emergency system for an aerial platform, to an aerial platform comprising said emergency system and to a related emergency method.

More specifically the invention relates to an emergency system and method comprising a system and a step for excluding the automatic function of levelling the aerial platform.

Therefore, the invention finds a useful application on aerial platforms of any type, particularly on aerial platforms provided with at least one inclinable arm supporting a basket.

### BACKGROUND

As it is well known, the aerial lifting platforms are machines for lifting people, generally mounted on trucks or movable structures, even radio-controlled ones, also suitable for use in construction sites or more generally on bumpy grounds. In some cases, they may be stationary and thus fixed to the ground by means of load-bearing structures made of reinforced concrete or steel.

An aerial platform has generally one or more arms for lifting to heights, the last of which supports a basket, which is the machine part in which people and possible equipment for working at heights are accommodated and protected.

There are essentially two types of aerial platforms: those specifically developed for this purpose or those derived from machines developed for lifting objects, such as cranes, telescopic handlers etc., which are then equipped with an optional basket for lifting people.

Both of the above types are here taken into consideration.

The main control and monitoring functions related to the basket are three: the control and safety control of levelling, that is of the condition of horizontality with respect to the ground; the control of the basket rotation with respect to a vertical axis; the safety control on the overall transported load.

Safety control means in particular all those activities managed by an automation system, which are required to ensure the operator integrity in the basket and/or on the ground.

In particular, the basket is fixed to the last arm by means of two rotating joints which are perpendicular to each other. The first one rotates on an axis which is parallel to the ground and allows the basket levelling, the second one rotates instead on an axis which is perpendicular to the ground and allows the basket rotation.

The levelling is a safety movement, since it aims at maintaining the basket horizontal and thus safe for operators. It must thus be controlled with high precision. The rotation is instead a maneuver movement, which is less critical.

In the aerial platforms according to the prior art, due to the forces involved, hydraulic actuators are the most adopted to perform the intended functions, by using an endothermic and/or electric motor to power a central hydraulic pump.

However, the forces required for levelling the basket and for the rotation thereof can also be managed by means of electric actuators.

As can be seen in FIG. 1, in addition to the one or more lifting arms 2 of the basket 3, an aerial platform 1000′ generally comprises a rotation fifth wheel 1001 positioned at the base.

The movements of the lifting arms 2 and of the rotation fifth wheel 1001 can be hydraulic or electro-hydraulic. In the first case the operator will act directly on the opening and closing of control valves by means of appropriate mechanical levers.

In the second case, the operator will instead manage the movements by means of electric or electronic controls.

In both cases the basket stability will not be entrusted to the operator, but to an automatic levelling system which is able to maintaining the horizontal orientation.

Like manual movement controls, the automatic levelling system can also be fully hydraulic or equipped with an electronic control system.

This control system controls a double-delivery valve which is able to adjust the movement of the stem of a cylinder or the rotation of the rotor of a hydraulic motor.

If the most rudimentary solutions are excluded, the valve is of the proportional type, which is able to continuously adjust the oil flow rate and thus to control the correction rate of the basket inclination.

An electronic levelling system 1002 associated with a hydraulic system 1003, as shown in FIG. 2, is certainly more complex than the hydraulic one, but it allows to form best-performing chains of lifting arms.

The electronic levelling is a system for controlling the basket inclination based on a device which is able to measure the inclination thereof and to automatically correct it during the movement of the arms.

This electronic system 1002 allows the machine operator to spatially control the position of the basket 3 without worrying about the inclination thereof.

With the current automatic electro-hydraulic levelling system, the exclusion of the automatism provides a simple lack of power supply to the electronic circuits and a direct action on the levelling valve.

In case of emergency, the operator will have to alternatively move the arms 2 and thus correct the inclination, acting on the valve, until the basket 3 is not repositioned on the ground or in any case in a safe position for transported people.

Despite the simplicity of exclusion based on the manual activation of the valve, the exclusion system of the levelling automatism determines hydraulic conditions which hinder the precise control of the levelling movement.

In fact, in order to exclude the automatic levelling from the ground station, also called emergency station, the manufacturer is forced to position the levelling valve at the base of the machine, at the rotation fifth wheel 1001, moving it away from the hydraulic actuator, positioned at the basket 3, and thus compromising the control precision.

Another solution, which is less used but still present on the market, which can be seen in FIGS. 3A and 3B, consists in positioning an inclination control valve 1004 at the basket 3 and connecting the hydraulic levelling circuit 1005 with a diverter tap 1006 positioned on the ground, in order to be able to exclude the above circuit and manually control the actuator from the ground station.

From the hydraulic point of view this solution is even more problematic than the previous one, since the pipes 1007 downstream of the inclination control valve 1004 are even longer.

As an alternative to the electro-hydraulic control with automatic electronic controls for linear or rotary hydraulic actuators, the electronic levelling based on an actuator or electric motor can be provided.

This belongs to the prior art by now, but the aerial platforms do not exploit it on a large scale.

The electronic levelling with electric motor allows to form simpler and lighter hydraulic systems, since it allows to electrically move the basket and thus it does not require heavy and bulky hydraulic pipes inside the telescopic arms.

An aerial platform with electric control according to the prior art is shown in FIG. 4.

The control system 100 is an independent unit, provided with a machine-side portion 101 and a basket-side portion 102. The machine-side portion 101 is fixed to at least one lifting arm 2 of the aerial platform 1000. The basket-side portion 102 is instead fixed to a basket 3 of the same aerial platform 100.

The control system 100 is structured in three different stages, which follow each other in a driveline which connects the lifting arm 2 to the basket 3, that is the machine-side portion 101, an intermediate portion 103 and the basket-side portion 102.

The machine-side portion 101 and the intermediate portion 103 are connected by a levelling articulated joint 107, which allows a relative rotation thereof along a horizontal axis x, according to the local reference of the Figure, in particular a levelling axis x.

In other words, the basket levelling consists in the rotation thereof about an axis which is parallel to the ground, in order to maintain the support board in a horizontal position and thus safe for transported people.

The intermediate portion 103 and the basket-side portion 102 are connected by a rotation articulated joint 104, which allows a relative rotation thereof along a vertical axis y, always according to the local reference of the Figure, in particular a rotation axis y.

However, nothing prevents to provide solutions with no rotation device or with a different rotation system.

In other words, the rotation consists instead in the rotary movement about an axis which is perpendicular to the ground and is not directly related to safety.

It is emphasized that here and below the terms “horizontal”, “vertical”, “high”, “low” and the like are used according to the traditional meaning thereof and with reference to the figures, which show the aerial platform in the normal operating conditions.

The frame of the machine-side portion 101 supports a levelling actuator 4 comprising a levelling electric motor 5, preferably, but not limitedly, a direct current motor with brushes or a stepper motor, and a mechanical reduction gear which brings the motion to a drive gear wheel (not shown).

Nothing prevents to provide different solutions, which adopt, for example, a so-called brushless system.

The levelling actuator 4 thus allows to modify the inclination of the basket 3 with respect to the lifting arm 2, to maintain the horizontality of said basket 3 with respect to the ground or soil.

In the here-described embodiment, the angular travel of the basket 3 about the levelling axis x is often equal to 270°, but a different angular travel can be provided.

The intermediate portion 103 is generally, but not limitedly, L-shaped, with the upper vertex coupled to a horizontal pin 105 and the lower vertex projecting towards the basket 3.

The control system 100 is generally managed by a control device 106, with one or more control units, on board the machine connected to the ground systems by means of a power supply cable and a serial bus and which controls both the levelling actuator 4 and the rotation actuator.

The control system 100 comprises an inclination sensor, which cannot be seen in FIG. 4, and implements an angular position control in order to ensure the horizontality of the basket 3. Generally, two different inclination measurements are acquired whose congruence is then verified.

In the absence of congruence between the measurements, the levelling actuator 4 is blocked.

The lack of use of this purely electric levelling system depends on cultural factors, but also on exclusion difficulties in case of failure of the motor electronic control system.

The exclusion of the automatic levelling system is in fact fundamental to ensure the basket recovery in emergency conditions.

Therefore, the technical problem underlying the present invention is to devise an emergency system for an aerial platform which allows to solve the problems related to the currently most used solutions, i.e. the hydraulic ones, solving the drawbacks reported when adopting fully electric systems.

Another object is to provide a solution which is inexpensive, reliable and flexible enough to be integrated in pre-existing aerial platforms or on pre-existing cranes.

### SUMMARY

The solution idea underlying the present invention is to provide a system which allows to bypass the electric automatic levelling of the basket in favour of a manual system, while not affecting the control precision.

Therefore, the above-identified technical problem is solved by an emergency system for an aerial platform comprising at least one lifting arm associated with a basket and a levelling actuator comprising a levelling electric motor.

The emergency system comprises a first automatic control circuit connected to the levelling electric motor, said first automatic control circuit comprising at least one inclination sensor which can be associated with the basket and a first power driver comprising a first control logic.

Furthermore, the emergency system comprises a second manual control circuit connected to the levelling electric motor, the second manual control circuit comprising a manual inclination control and a second power driver comprising a second control logic.

The emergency system then comprises at least one diverter adapted to alternatively exclude a first functional connection or a second functional connection of the levelling electric motor, respectively with the first automatic control circuit or the second manual control circuit.

Advantageously, the system thus provides an exclusion of the automatic levelling function in favour of a manual system which does not affect the control precision, using an electric motor as a levelling actuator.

This electronic exclusion allows the exclusion of the electronic control device and of the power driver in favour of a second controller also manually controlled from the ground and independently of the inclination sensors.

Advantageously, this electronic exclusion allows the emergency manual control on the occasion of failure conditions, replacing the power circuits that power the motor and the electronic controller containing the levelling logic with an alternative manually controlled driver and thus replacing all the potentially faulty electronic circuits with a simpler and functioning system, only and exclusively used for emergency maneuvers.

In order to avoid conditions blocking the emergency activities caused by a possible failure of the diagnostic system, the machine operator can however, preferably, force the exclusion of the automatic control system.

Upon ignition, the operator can thus send a control to force the permanent activation of the emergency system.

The emergency controls are generally three, that is forced exclusion of automatic levelling, activation of clockwise orientation, also called clockwise correction, activation of counterclockwise orientation, also called counterclockwise correction.

Preferably, the emergency system provides the adoption of two diverters.

Advantageously, it is thus possible to create separate logic circuits which lead to the automatic control and the emergency control.

Still preferably, the emergency system further comprises a ground emergency control connected to the second power driver of the second manual control circuit by means of conductors housed inside the lifting arm or by means of a radio connection or the like.

Advantageously, this ensures a further redundancy of the controls, which is very important in technologies related to the operator safety.

According to a different aspect, the present invention relates to an emergency method for an exclusion of the automatic levelling of an aerial platform comprising an emergency system as described above.

This method comprising the following steps:
activation of the aerial platform;
second automatic functional connection of the second manual control circuit to the levelling electric motor and exclusion of the first functional connection of the first automatic control circuit to the levelling electric motor by means of the at least one diverter;
testing step of the correct operation of the first automatic control circuit;
in case of positive outcome of the testing step, exclusion of the second functional connection of the second manual control circuit to the levelling electric motor by means of the at least one diverter and first functional connection of the first automatic control circuit to the levelling electric motor;
in case of negative outcome of the testing step, maintaining the second functional connection of the second manual control circuit to the levelling electric motor.

The at least one diverter, and preferably the two diverters allow to connect the electric motor to the automatic electronic control or to the emergency driver.

The first one is able to maintain the basket horizontal during the movement of the at least one lifting arm and it receives information from the inclination sensor, from the logic control and from the power driver powering the motor.

The second one is instead a power driver with a control logic, which is able to receive the manual controls for clockwise and counterclockwise rotation.

Upon ignition the at least one diverter, in normal conditions, connects the motor to the emergency driver, the automatic system performs the testing procedure and if the latter is concluded positively the at least one diverter will be activated to connect the motor to the automatic control system.

Preferably, the testing step comprises a first no-load control testing step of the correct operation of the at least one inclination sensor and of the first control logic.

More preferably, the testing step further comprises a second under-load control testing step comprising a first functional connection lasting less than or 1 second of the first automatic control circuit to the levelling electric motor, to verify the operation of the first power driver.

In other words, advantageously, during the first test the motor is connected to the emergency driver and the automatic control system controls the logic circuits, the inclination sensor or sensors and the driver logic circuits.

As an alternative, nothing prevents to provide a first test of a different nature with disconnected motor.

During the second test the motor is instead temporarily connected to the automatic control which can inject current into the motor to perform the test of power circuits. The first temporary connection of the motor to the automatic system only lasts the fractions of a second required for the second test. Only when the second test is concluded positively in the set time the emergency driver definitely excludes itself and the control of the motor passes to the automatic system.

After the initial test, the management of the safety functions defined by the regulations in force is entrusted to the automatic control.

The above-presented technical problem is also solved by an aerial platform comprising at least one lifting arm associated with a basket with a levelling articulated joint along a levelling axis and a levelling actuator comprising a levelling electric motor and at least one emergency system of the above-described type.

Advantageously, an aerial platform of this type combines the advantages of a fully electric system with the possibility of having a correct and precise manual control system of the manual levelling.

Preferably, the aerial platform according to the invention further comprises power supply conductors and communication digital bus conductors in the lifting arm, these communication digital bus conductors being also connectable to the second power driver of the second manual control circuit.

In order to maintain the emergency driver as simple as possible and thus as sturdy as possible the controls, which may be preferably activated through an emergency key by specific operators, may also be implemented through electric switches positioned at the base of the lifting arm, in the emergency ground station.

However, the communication digital bus conductors may also be connected to the emergency power driver to replace the electro-mechanical controls, that is by means of switches.

Thus, advantageously, since the current aerial platforms are managed by digital electronic controls, the automatic levelling system may be connected to the controls by means of a digital bus to receive controls and send data related to the basket inclination.

According to an embodiment, the aerial platform according to the invention further comprises a speed reducer also acting as a torque multiplier configured to allow a rotation of the axis of the levelling electric motor by means of a crank.

In other words, a transmission is provided, which can be accessed from the basket and controlled by means of the crank inserted on the shaft of the levelling electric motor, directly intervening on the rotation axis of the levelling electric motor and completely excluding the first automatic control circuit to cut the existing connection with the basket levelling.

In fact, unlike hydraulic actuators, the electric motor requires the speed reducer which also acts as a torque multiplier, therefore allowing the rotation of the motor axis by means of a simple crank.

As an alternative, according to another embodiment, the aerial platform according to the invention further comprises a secondary motor for the total exclusion of the first automatic control circuit.

Said secondary motor, depending on the contingent needs, may advantageously be electric, pneumatic or of another nature and also controlled by the ground emergency station.

Advantageously, it is thus possible, if necessary, to differently exclude the first automatic control circuit by cutting the existing connection with the basket levelling.

The features and advantages of the emergency system according to the invention will be apparent from the following description of exemplary embodiments given by way of non-limiting examples with reference to the attached drawings.

### BRIEF DESCRIPTION OF THE DRAWINGS

In the drawings:

FIG. 1 schematically shows an aerial platform according to the prior art;

FIG. 2 schematically shows an aerial platform with electro-hydraulic control according to the prior art;

FIGS. 3A and 3B schematically show an operation of an aerial platform with electro-hydraulic control according to the prior art;

FIG. 4 schematically shows an aerial platform with electric control according to the prior art;

FIG. 5 shows an operation diagram of an emergency system according to the invention;

FIG. 6 shows a portion of the operation diagram of FIG. 5;

FIG. 7 shows a portion of the operation diagram of FIG. 5;

FIG. 8 shows a block diagram which describes a method of operation according to the invention;

FIG. 9 schematically shows a detail of an embodiment of an aerial platform according to the invention.

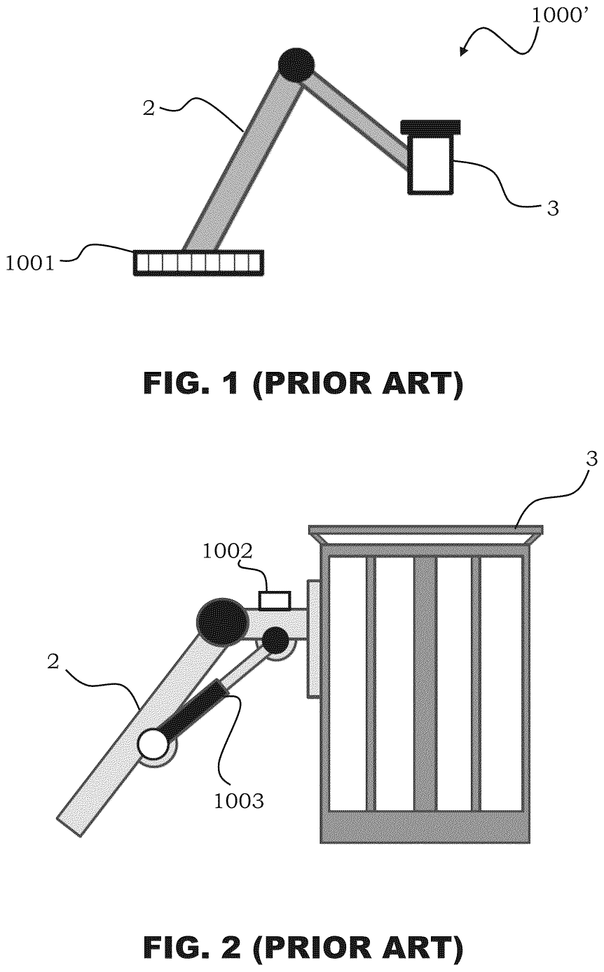

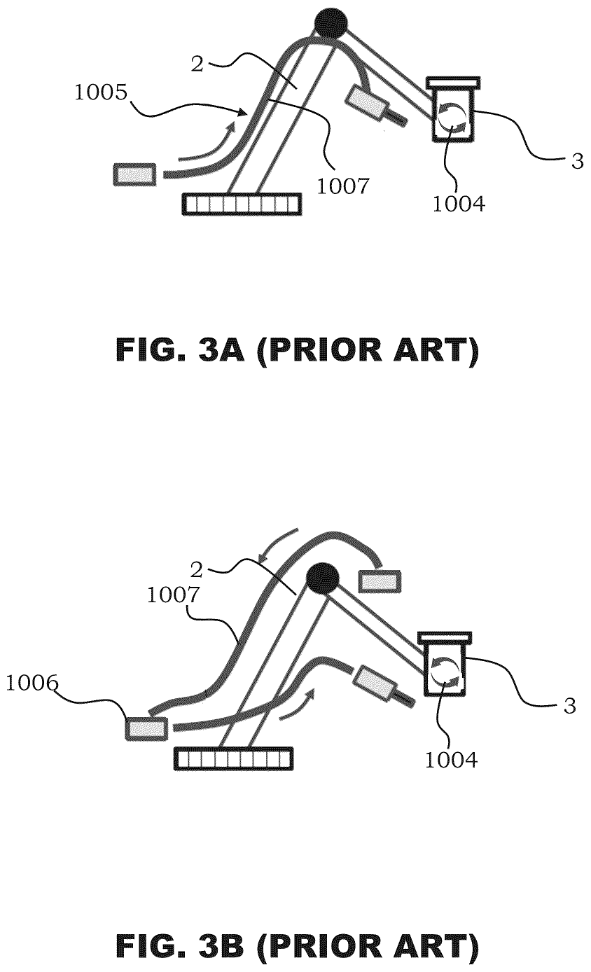

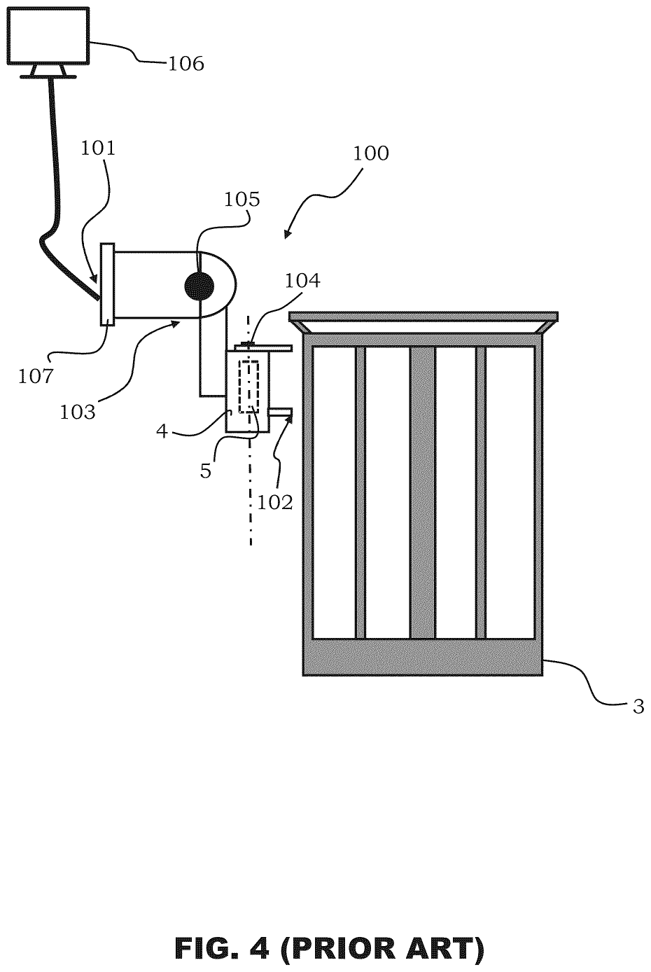

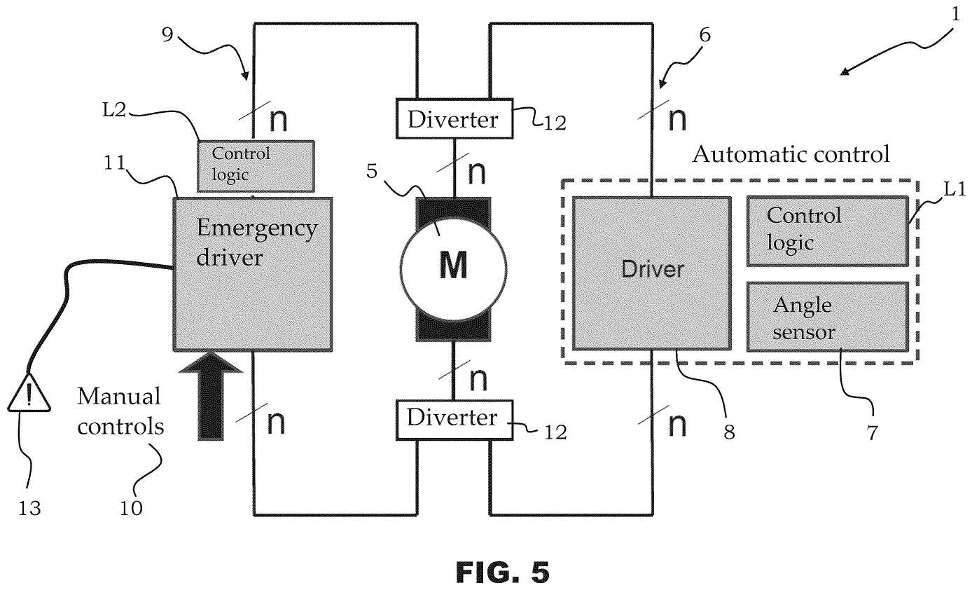

### DETAILED DESCRIPTION OF EMBODIMENTS

Referring to FIGS. 5-9, an emergency system which can be coupled to an aerial platform 1000 is generically identified with 1.

It is specified that elements, which are similar to the above-described prior art solutions, will be indicated by the same reference numbers.

The aerial platform 1000 comprises at least one lifting arm 2 associated with a basket 3 with a levelling articulated joint 107 according to a levelling axis x, a levelling actuator 4 comprising a levelling electric motor 5 and at least one emergency system 1.

The emergency system 1 allows the emergency manual control on the occasion of failure conditions of the aerial platform 1000.

The emergency system 1 allows, in fact, the replacement of the power circuits which power the levelling electric motor 5 and of the control device 106 containing the levelling logic with an alternative manually controlled driver.

All the potentially faulty electronic circuits are thus replaced with a simpler and functioning system, basically used for emergency maneuvers.

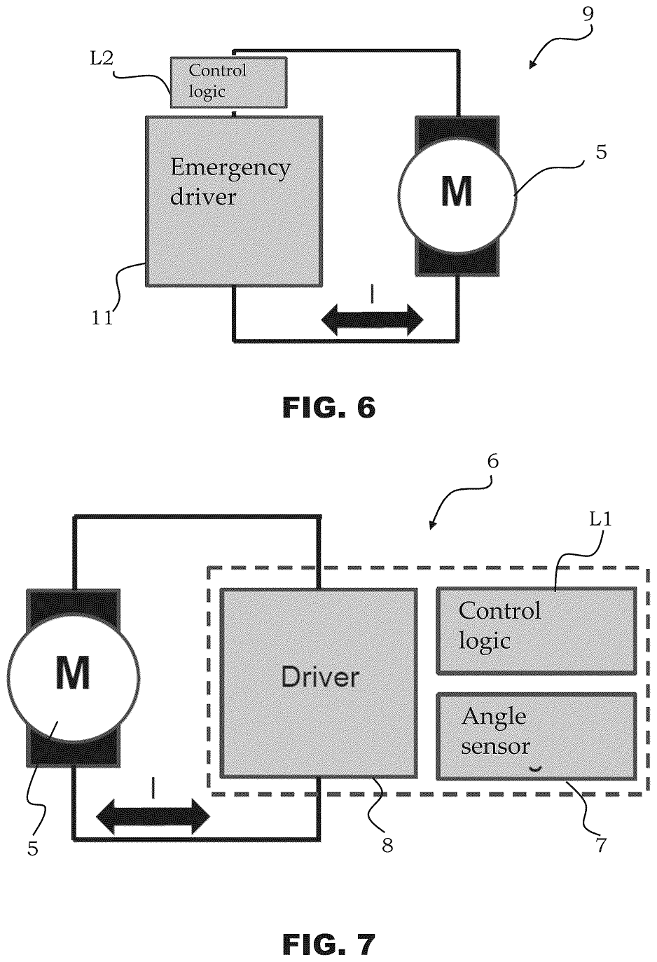

Specifically, as globally schematically represented in FIG. 5 and in detail in FIGS. 6 and 7, the emergency system 1 comprises a first automatic control circuit 6 connected to the levelling electric motor 5.

Similarly to the control system 100 according to the prior art, the first automatic control circuit 6 comprises at least one inclination sensor 7 which can be associated with the basket 3.

The first automatic control circuit 6 further comprises a first power driver 8 comprising a first control logic L1.

Furthermore, the emergency system 1 comprises a second manual control circuit 9 always connected to the levelling electric motor 5 and which comprises a manual inclination control 10 and a second power driver 11 comprising a second control logic L2.

The emergency controls are generally three, that is forced exclusion of automatic levelling, activation of clockwise orientation, also called clockwise correction, activation of counterclockwise orientation, also called counterclockwise correction.

In order to maintain the emergency driver as simple as possible and thus as sturdy as possible the controls, which may be preferably activated through an emergency key by specific operators, may also be implemented through electric switches positioned at the base of the lifting arm, in the emergency ground station.

The current flow between the levelling electric motor 5 and the first automatic control circuit 6 and between the levelling electric motor 5 and the second manual control circuit 9 is also schematically shown in FIGS. 6 and 7, respectively.

At least one diverter 12 is then provided, adapted to alternatively exclude a first functional connection or a second functional connection of the levelling electric motor 5, respectively with the first automatic control circuit 6 or the second manual control circuit 9.

In the represented embodiment two diverters 12 are preferably provided, the first one intended to connect the levelling electric motor 5 to the first automatic control circuit 6 and the second one intended to connect the levelling electric motor 5 to the second manual control circuit 9.

The first one is able to maintain the basket 3 horizontal during the movement of the one or more lifting arms 2, whereas the second one is able to receive the manual controls for clockwise and counterclockwise rotation.

In the represented embodiment, a ground emergency control 13 connected to the second power driver 11 of the second manual control circuit 9 by means of conductors housed inside the one or more lifting arms 2 is further preferably provided.

Nothing prevents to provide alternative solutions, such as, for example, but not limitedly, a radio connection or the like.

More in particular, the aerial platform 1000 comprises power supply conductors and communication digital bus conductors in the lifting arm 2, said communication digital bus conductors being also connectable to the second power driver 11 of the second manual control circuit 9.

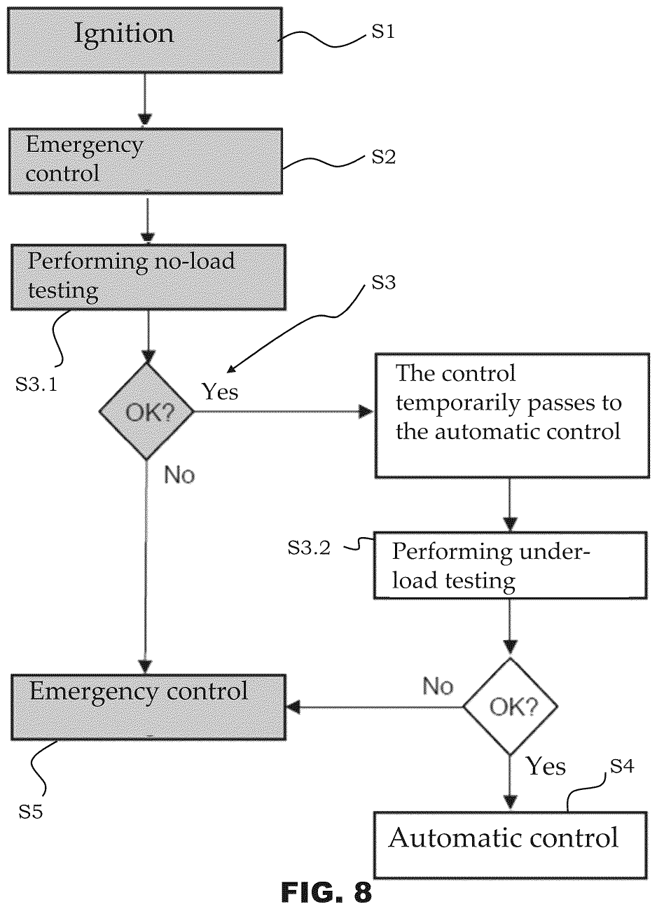

In accordance with the present invention, as outlined in the block diagram of FIG. 8, the emergency system 1 provides a series of operating steps following the step S1 of activation of the aerial platform 1000.

In particular, the emergency system 1 provides a step S2 with the second automatic functional connection of the second manual control circuit 9 to the levelling electric motor 5 and exclusion of the first functional connection of the first automatic control circuit 6 to the levelling electric motor 5 by means of the at least one diverter 12.

A testing step S3 of the correct operation of the first automatic control circuit 6 is then initiated.

In the represented preferred embodiment, the testing step S3 provides a first no-load control testing step S3.1 of the correct operation of the at least one inclination sensor 7 and of the first control logic L1.

If this step S3.1 is concluded with a positive verification of said operation a second under-load control step S3.2 is also preferably provided, comprising the first functional connection lasting less than or 1 second of the first automatic control circuit 6 to the levelling electric motor 5, to verify the operation of the first power driver 8.

In case of positive outcome of the testing step S3, a step S4 of excluding the second functional connection of the second manual control circuit 9 to the levelling electric motor 5 by means of the intended diverter 12 and the first functional connection of the first automatic control circuit 6 to the levelling electric motor 5 is performed.

Otherwise, in case of negative outcome of the testing step S3, and of subsequent detection of a type of malfunction of the automatic control circuit 6, a step S5 of maintaining the second functional connection of the second manual control circuit 9 to the levelling electric motor 5 is performed.

In short, upon activation the diverters 12, in normal conditions, connect the levelling electric motor 5 to the second manual control circuit 9, specifically to the second emergency power driver 11, the automatic control circuit 6 is subject to a testing procedure and only if the latter is positively concluded the diverters 12 will be activated to connect the levelling electric motor 5 to the first automatic control circuit 6.

Furthermore, in a preferred embodiment, the aerial platform 1000 also allows to have a total exclusion of the automatic control circuit 6.

This may be made by a direct intervention on the levelling electric motor 5.

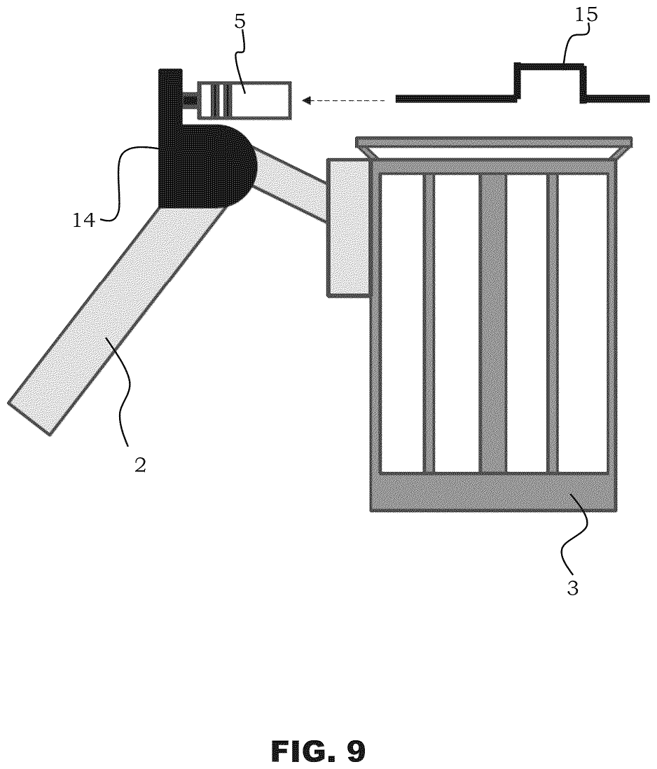

More specifically, the levelling electric motor 5 further comprises a speed reducer 14 also acting as a torque multiplier configured to allow, as can be seen in FIG. 9, a rotation of the axis of the levelling electric motor by means of a crank 15.

In other words, a transmission is provided, which can be accessed from the basket 3 and controlled by means of the crank 15 inserted on the shaft of the levelling electric motor 5, directly intervening on the rotation axis of the levelling electric motor 5 and completely excluding the first automatic control circuit 6 to cut the existing connection with the levelling of the basket 3.

Alternatively, according to another embodiment not being shown, the aerial platform 1000 according to the invention further comprises a secondary motor for the total exclusion of the first automatic control circuit.

Said secondary motor, depending on the contingent needs, may advantageously be electric, pneumatic or of another nature and also controlled by the ground emergency station.

Advantageously, it is thus possible, if necessary, to differently exclude the first automatic control circuit 6 by cutting the existing connection with the levelling of the basket 3.

Obviously, in order to meet contingent and specific requirements, a person skilled in the art will be allowed to bring several modifications and variants to the above-described power supply system, all falling within the scope of protection of the invention as defined by the following claims.

For example, nothing prevents to apply the emergency system 1 to different types of aerial platforms.

1. An emergency system for an aerial platform, the aerial platform comprising:
at least one lifting arm associated with a basket and a levelling actuator comprising a levelling electric motor, and the emergency system comprising:
a first automatic control circuit connected to said levelling electric motor, said first automatic control circuit comprising at least one inclination sensor which can be associated with said basket and a first power driver comprising a first control logic;
a second manual control circuit connected to said levelling electric motor, said second manual control circuit comprising a manual inclination control and a second power driver comprising a second control logic; and
at least one diverter adapted to alternatively exclude a first functional connection of said levelling electric motor with said first automatic control circuit or a second functional connection with said second manual control circuit.

2. The emergency system according to claim 1, further comprising two diverters.

3. The emergency system according to claim 1, further comprising a ground emergency control connected to said second power driver of said second manual control circuit by conductors housed inside said lifting arm or by a radio connection.

4. An emergency method for an exclusion of the automatic levelling of an aerial platform comprising an emergency system according to claim 1, said method comprising steps of:
step S1: activation of said aerial platform;
step S2: said second automatic functional connection of said second manual control circuit to said levelling electric motor and exclusion of said first functional connection of said first automatic control circuit to said levelling electric motor by means of said at least one diverter;
step S3: testing step of the correct operation of said first automatic control circuit;
step S4: in case of positive outcome of said testing step, exclusion of said second functional connection of said second manual control circuit to said levelling electric motor by means of said at least one diverter and first functional connection of said first automatic control circuit to said levelling electric motor; and
step S5: in case of negative outcome of said testing step, maintaining said second functional connection of said second manual control circuit to said levelling electric motor.

5. The method according to claim 4, wherein said testing step S3 comprises a first no-load control testing step S3.1 of the correct operation of said at least one inclination sensor and of said first control logic.

6. The method according to claim 5, wherein said testing step S3 comprises a second under-load control testing step S3.2 comprising a first functional connection lasting less than or 1 second of said first automatic control circuit to said levelling electric motor, to verify the operation of said first power driver.

7. An aerial platform comprising at least one lifting arm associated with a basket with a levelling articulated joint along a levelling axis and a levelling actuator comprising a levelling electric motor and at least one emergency system according to claim 1.

8. The aerial platform according to claim 7, further comprising power supply conductors and communication digital bus conductors in said lifting arm, said communication digital bus conductors being also connectable to said second power driver of said second manual control circuit.

9. The aerial platform according to claim 7, further comprising a speed reducer also acting as a torque multiplier configured to allow a rotation of the axis of said levelling electric motor by means of a crank.

10. The aerial platform according to claim 7, further comprising a secondary motor for the total exclusion of said first automatic control circuit.
